(19) United States
(12) Patent Application Publication
(10) Pub. No.: US 2026/0307398 A1
(43) Pub. Date: Oct. 8, 2026

(54) IMAGE PROCESSING APPARATUS, PRINTER, AND NON-TRANSITORY STORAGE MEDIUM

(71) Applicant: Hisashi Tsujimura, Mishima Shizuoka (JP)

(72) Inventor: Hisashi Tsujimura, Mishima Shizuoka (JP)

(73) Assignee: ETRIA Co., Ltd., Kanagawa (JP)

(21) Appl. No.: 19/444,534

(22) Filed: Jan. 9, 2026

(30) Foreign Application Priority Data
Apr. 8, 2025 (JP) 2025-063746

(51) Int. Cl. B41J 2/36; B41J 2/325

(52) U.S. Cl. CPC B41J 2/362; B41J 2/325

(57) ABSTRACT

According to an embodiment, an image processing apparatus includes a memory and a processor. The memory stores setting information that sets the number of continuous print dots in the main scanning direction and the number of continuous print dots in the sub scanning direction, which are thinning conditions to execute thinning of print dots. The processor generates second image data by thinning, in accordance with the setting information, print dots from a print dot group for which the number of continuous print dots in the main scanning direction and the number of continuous print dots in the sub scanning direction in first image data match the thinning conditions.

### CROSS REFERENCE TO RELATED APPLICATIONS

This application is based upon and claims the benefit of priority from Japanese Patent Application No. 2025-063746, filed Apr. 8, 2025, the entire contents of which are incorporated herein by reference.

### FIELD

Embodiments described herein relate generally to an image processing apparatus, a printer, and a non-transitory storage medium.

### BACKGROUND

A thermal transfer type printer (thermal printer) that is an image forming apparatus includes a thermal head as a thermal head formed by arraying heating elements on a print line. The conventional thermal printer generally performs print while executing heat history control of controlling the optimum energization time (energy) applied to the thermal head based on the data of a line to be printed for each print line and data printed in the past.

In the conventional thermal printer, however, controlling the heat history alone causes trailing (a phenomenon that unnecessary print occurs due to heat remaining in the heating elements) due to application of too much energy or print blur because of short energy. Also, when performing print using already rendered data such as image data of a specific data format, it is difficult for the thermal printer to adjust image data for print after receiving a print command.

### BRIEF DESCRIPTION OF THE DRAWINGS

FIG. 1 is a perspective view showing an example of the outer appearance of a thermal printer that is a printer including an image processing apparatus according to an embodiment.

FIG. 2 is a schematic sectional view showing an example of the internal configuration of the thermal printer that is the printer including the image processing apparatus according to the embodiment.

FIG. 3 is a block diagram showing an example of the configuration of a control system in the thermal printer that is the printer including the image processing apparatus according to the embodiment.

FIG. 4 is a view showing an example of setting of thinning processing in the thermal printer that is the printer including the image processing apparatus according to the embodiment.

FIG. 5 is a view showing an example of image data that has undergone the thinning processing by the thermal printer that is the printer including the image processing apparatus according to the embodiment.

FIG. 6 is a view showing an example of image data that has undergone the thinning processing by the thermal printer that is the printer including the image processing apparatus according to the embodiment.

FIG. 7 is a flowchart for explaining the procedure of print processing including thinning processing by the thermal printer that is the printer including the image processing apparatus according to the embodiment.

### DETAILED DESCRIPTION

According to an embodiment, an image processing apparatus includes a memory and a processor. The memory stores setting information that sets the number of continuous print dots in the main scanning direction and the number of continuous print dots in the sub-scanning direction, which are thinning conditions to execute thinning of print dots. The processor generates second image data by thinning, in accordance with the setting information, print dots from a print dot group for which the number of continuous print dots in the main scanning direction and the number of continuous print dots in the sub-scanning direction in first image data match the thinning conditions.

A thermal printer that is a printer including the image processing apparatus according to the embodiment will now be described with reference to the accompanying drawings.

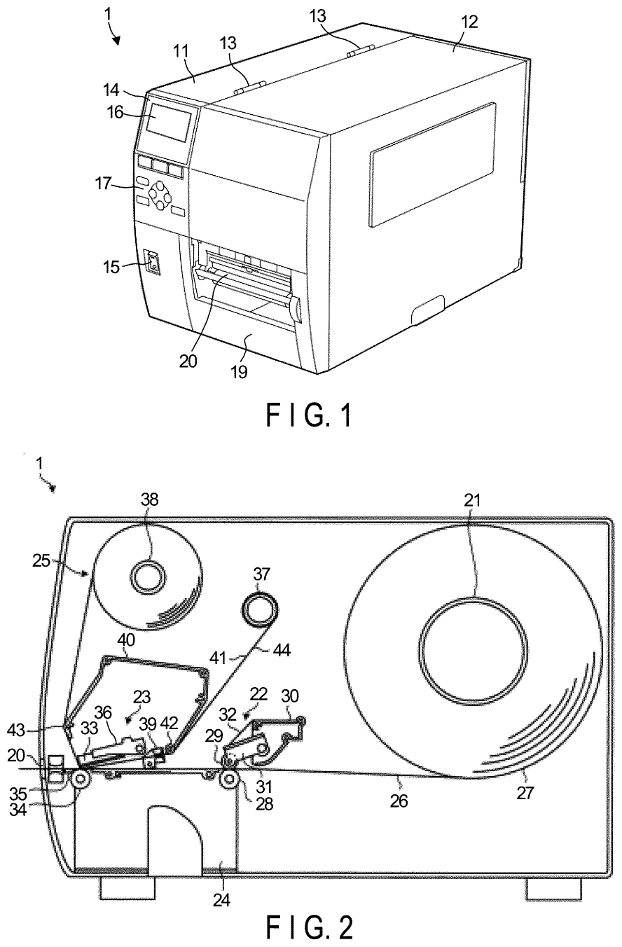

FIG. 1 is a perspective view showing an example of the outer appearance of a thermal printer 1 that is a printer including the image processing apparatus according to this embodiment.

In the configuration example shown in FIG. 1, the thermal printer 1 includes a case 11 on the left side, and a case 12 connected to the right side of the case 11 by hinges 13. A front panel 14 of the case 11 includes a power switch 15, a display unit 16, an operation unit 17, and the like. The display unit 16 is formed by, for example, a liquid crystal display with a backlight. However, a display device other than the liquid crystal display may be used for the display unit 16. For example, the display unit 16 and the operation unit 17 may be formed by a display device with a touch panel.

The case 12 on the right side has a structure capable of largely opening the inside of the housing (that is, the cases 11 and 12) by rotating the hinges 13. The thermal printer 1 includes, in the housing, a medium (paper sheet) 27 wound into a roll, an ink ribbon 41 suspended on two shafts, and a print unit 23 that performs print using the ink ribbon. The thermal printer 1 has a structure capable of exchanging the ink ribbon 41 or the paper sheet 27 or performing maintenance of the inside by rotating the hinges 13 and thus moving the case 12 upward. A front panel 19 of the case 12 is provided with an issue port 20. The thermal printer 1 issues, from the issue port 20, a medium (label) after print processing (image formation processing).

FIG. 2 is a schematic sectional view showing an example of the internal configuration of the thermal printer 1. As shown in FIG. 2, the thermal printer 1 includes, in the housing, a paper holding unit 21, a paper conveyance unit (conveyance unit) 22, a print unit 23, a frame 24, an ink ribbon supply device 25, and the like.

The paper holding unit 21 is a shaft that winds the paper sheet 27 as a print medium into a roll and holds it. The paper sheet 27 is drawn from the paper holding unit 21, passed through the paper conveyance unit 22, printed by the print unit 23, and discharged from the issue port 20. The paper sheet 27 can be, for example, a medium (label paper) with a label adhered to a mount, or may be a medium that is to be cut in a predetermined length in the conveyance direction after print processing. The paper sheet 27 used as a print medium is not limited to a medium to which ink is transferred, and may be thermal paper.

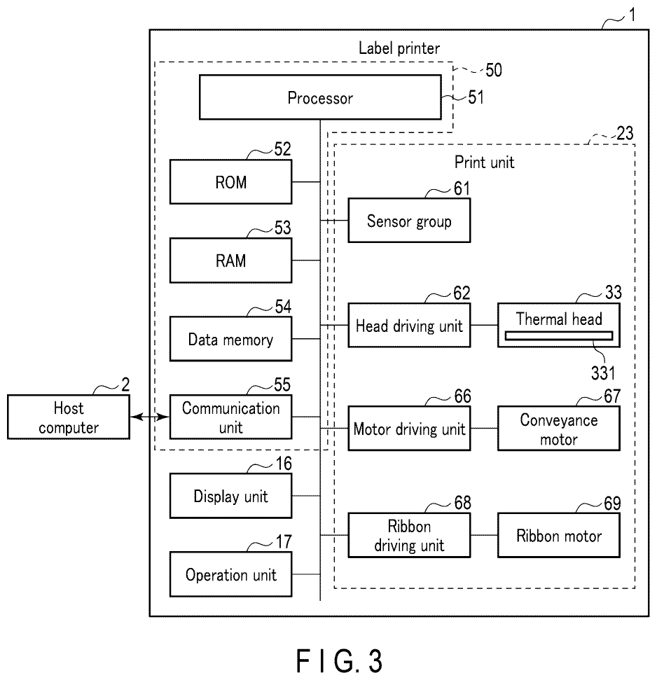

The paper conveyance unit 22 includes a paper conveyance roller 28, a pinch roller 29, a frame 30, a support unit 31, a leaf spring 32, and the like. The pinch roller 29 is rotatably supported by the support unit 31. The paper conveyance roller 28 and the pinch roller 29 abut against each other via the paper sheet 27 conveyed on a conveyance path 26. The paper conveyance roller 28 is rotatably attached to the frame 24, driven by a drive structure including a conveyance motor 67 (see FIG. 3) to be described later, and rotated.

The support unit 31 is swingably attached to the frame 30. Also, one end of the leaf spring 32 is attached to the frame 30, and the other end of the leaf spring 32 abuts against the pinch roller 29. The pinch roller 29 is configured such that it is biased by the leaf spring 32 to abut against the paper conveyance roller 28.

The conveyance path 26 of the paper sheet 27 starts from a portion where the paper sheet 27 is drawn from the paper holding unit 21. The conveyance path 26 passes through a position where the pinch roller 29 and the paper conveyance roller 28 abut against each other in the paper conveyance unit 22. Furthermore, the conveyance path 26 passes through a position where a thermal head (printhead) 33 and a platen 34 of the print unit 23 abut against each other and is terminated at the issue port 20.

Also, in the configuration example shown in FIG. 2, in the conveyance path 26, a label peeling plate 35 is provided on the downstream side of the print unit 23 in the conveyance direction. If the paper sheet 27 is label paper, the label peeling plate 35 bends the paper sheet 27 under conveyance, thereby peeling the label from the mount. The peeled mount is wound by a winding shaft (not shown), and the label peeled from the mount is issued from the issue port 20.

The print unit 23 includes the thermal head 33 and the platen 34. The thermal head 33 is a line-type thermal printer head. The thermal head 33 has a configuration in which a plurality of heating elements 331 corresponding to one line (print line) are arranged in the main scanning direction that is a direction orthogonal to the conveyance direction of the paper sheet 27. The heating elements 331 of the thermal head 33 print dots of an image to be formed on the paper sheet 27. Each heating element 331 of the thermal head 33 includes a resistor and the like and is connected to a driving circuit (driver). Each heating element 331 of the thermal head 33 generates heat upon receiving a predetermined voltage applied (energized) by the driving circuit.

For each heating element 331 of the thermal head 33, time (application time or energization time) and count (application count or energization count) to apply a voltage (energize) to print one dot in accordance with a print condition are controlled. The heat generation state of each heating element 331 of the thermal head 33 is controlled by controlling the application time and the application count.

The platen 34 is rotatably attached to the frame 24 and is rotationally driven by a driving unit. The platen 34 rotates to convey the paper sheet 27 on which an image is to be printed. The thermal head 33 is provided facing the platen 34. The thermal head 33 performs print processing for the paper sheet 27 conveyed between it and the platen 34. The thermal head 33 is fixed to a head holding unit 36 rotatably attached to the frame.

The ink ribbon supply device 25 includes a ribbon holding shaft 37, a ribbon winding shaft 38, a ribbon end sensor 39, and a guide frame 40. The unused ink ribbon 41 is wound in a roll on the ribbon holding shaft 37. A guide roller 42 configured to guide the ink ribbon 41 drawn from the ribbon holding shaft 37 is provided at the end portion of the guide frame 40 on the side of the ribbon holding shaft 37. The guide roller 42 is rotatably provided on the guide frame 40.

The ink ribbon 41 before print abuts against the guide roller 42, passes through the detection target region of the ribbon end sensor 39, and reaches a position where the thermal head 33 and the platen 34 abut against each other, and ink is transferred by the thermal head 33. The ink ribbon 41 after print abuts against an end portion 43 of the guide frame 40 on the side of the ribbon winding shaft 38, and is then wound on the ribbon winding shaft 38 and collected.

That is, a conveyance path 44 of the ink ribbon 41 starts from a portion where the ink ribbon 41 is drawn from the ribbon holding shaft 37 and passes through a position where the ink ribbon 41 abuts against the guide roller 42 of the guide frame 40. The conveyance path 44 sequentially passes through the detection target region of the ribbon end sensor 39 and the position (that is, the print position) where the thermal head 33 and the platen 34 abut against each other. Furthermore, the conveyance path 44 passes through a position where the ink ribbon abuts against the end portion 43 of the guide frame 40 and is terminated at the portion where the ink ribbon is wound on the ribbon winding shaft 38.

The ribbon end sensor 39 is a sensor that detects the ribbon end, that is, the end of the ink ribbon 41. As shown in FIG. 2, the ribbon end sensor 39 is arranged on the conveyance path 44 between the print unit 23 and the ribbon holding shaft 37. The ribbon end sensor 39 is provided, for example, along the conveyance path 44 of the ink ribbon 41 and provided between the print unit 23 and the guide roller 42 on the conveyance path 44. The ribbon end sensor 39 may be provided between the guide roller 42 and the position (that is, the print position or transfer position) where the thermal head 33 and the platen 34 abut against each other in the print unit 23.

Note that if the guide frame 40 is of a type in which it does not include the guide roller 42, the installation position of the ribbon end sensor 39 is between the position where the thermal head 33 and the platen 34 abut against each other and the end portion of the guide frame 40 on the side of the ribbon holding shaft 37.

As the ribbon end sensor 39, an optical sensor that optically detects the ink ribbon 41 can be used. As a preferable example, a reflected light sensor including a light emitting element and a light receiving element is used as the ribbon end sensor 39. Note that a sensor that mechanically detects the ink ribbon 41 may be used as the ribbon end sensor 39.

The configuration of a control system in the thermal printer 1 that is the image forming apparatus according to the embodiment will be described next.

FIG. 3 is a block diagram showing an example of the configuration of the control system in the thermal printer 1 that is the image forming apparatus according to the embodiment.

As shown in FIG. 3, the thermal printer 1 includes, as the components of the control system, a processor 51, a ROM (Read Only Memory) 52, a RAM (Random Access Memory) 53, a data memory 54, a communication unit 55, the display unit 16, the operation unit 17, the print unit 23, and the like. Also, the print unit 23 includes a sensor group 61, a head driving unit 62, the thermal head 33, a motor driving unit 66, a conveyance motor 67, a ribbon driving unit 68, a ribbon motor 69, and the like.

The processor 51 is connected to the ROM 52, the RAM 53, the data memory 54, the communication unit 55, the display unit 16, the operation unit 17, the sensor group 61, the head driving unit 62, the motor driving unit 66, the ribbon driving unit 68, and the like via a bus line. The bus line includes an address bus, a data bus, a control signal line, and the like. The processor 51 is connected, via the bus line, to the units directly or via a signal input/output circuit and configured to transmit data signals exchanged between these.

The processor 51 is a hardware processor that generally controls the thermal printer 1. The processor 51 controls the units of the thermal printer 1 in accordance with an operating system or a control program. The processor 51 is, for example, a CPU (Central Processing Unit). The processor 51 may include an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), or an FPGA (Field-Programmable Gate Array).

The ROM 52 is a nonvolatile memory. The ROM 52 stores programs to be executed by the processor 51 and various kinds of data.

The RAM 53 is a volatile memory. The RAM 53 is a memory that temporarily holds data. For example, the RAM 53 operates as a deployment memory that temporarily stores a program or data when the processor 51 executes a program.

The data memory 54 corresponds to an auxiliary storage portion. The data memory 54 is a rewritable nonvolatile memory. The data memory 54 is formed by, for example, an HDD (Hard Disc Drive), an SSD (Solid State Drive), or the like. The data memory 54 stores data used by the processor 51 to perform various kinds of processing and data created by the processing of the processor 51.

The communication unit 55 is a communication interface configured to communicate with a host computer 2 provided outside or a user terminal. For example, the communication unit 55 is communicably connected to the host computer 2 and receives a print command (print instruction) and print data for print, which are supplied from the host computer 2.

Also, the processor 51, the ROM 52, the RAM 53, the data memory 54, the communication unit 55, and various kinds of interfaces form a control unit 50 functioning as an image processing apparatus. In the control unit 50, the processor 51 implements various processing functions to be described later by executing programs. The programs to be executed by the processor 51 are stored (installed) in a non-transitory nonvolatile memory such as the ROM 52 or the data memory 54. Some or all of various kinds of processing functions to be described later may be executed by a hardware circuit provided in the control unit 50.

For example, the program to be installed in the control unit 50 may be recorded as a file of an installable or executable format in a computer-readable recording medium such as a CD-ROM, a flexible disk (FD), a CD-R, or a DVD (Digital Versatile Disk) and provided. Also, the program to be installed in the control unit 50 may be stored on a computer connected to a network such as the Internet and downloaded to the control unit 50 via the network. The program to be installed in the control unit 50 may be provided or distributed via a network such as the Internet.

The display unit 16 is formed by a display device that displays information. The display unit 16 is provided at a position where the operator of the thermal printer 1 can visually recognize the display screen. The display unit 16 displays the operation guide of the thermal printer 1, information indicating the state of the thermal printer 1, or the like.

The operation unit 17 is formed by an input device used by the operator to input an operation instruction. The input device as the operation unit 17 includes, for example, various input buttons and a touch panel. Also, the display unit 16 and the operation unit 17 may be formed by a display device with a touch panel.

The print unit 23 prints an image on a label as a medium by the thermal head 33 heating the ink ribbon. The sensor group 61 including various kinds of sensors is arranged in the print unit 23. The sensor group 61 includes, for example, sensors such as a sensor that detects the conveyed medium and a sensor that detects the ink ribbon. The processor 51 controls the units of the print unit 23 based on the detection result of each sensor of the sensor group 61, or the like.

The head driving unit 62 is connected to the thermal head 33. The head driving unit 62 drives the thermal head 33. The thermal head 33 is provided at a predetermined print position. The thermal head 33 includes the plurality of heating elements (elements) 331 arranged on a print line in the direction (main scanning direction) orthogonal to the conveyance direction (sub-scanning direction) of the medium at the print position. The thermal head 33 is arranged such that the plurality of heating elements 331 contact, at the print position, the ink ribbon overlaid on the label and conveyed. The thermal head 33 performs print on the label paper as the individual heating elements 331 apply, on the print line, heat to the ink ribbon overlaid on the label paper and conveyed.

The head driving unit 62 includes a driving circuit for the heating elements 331 of the thermal head 33 and causes the heating elements 331 to generate heat based on a print image. For example, the head driving unit 62 controls the heat generation state of the heating elements 331 of the thermal head 33 based on the image data of each print line in the print image of each page to be printed don the medium. The heating elements 331 that generate heat at the predetermined print position heat the ink ribbon (or thermal paper) pressed against the print medium (label material). Thus, the heating elements 331 perform print of print dots (transfer of the ink ribbon or color development of thermal paper) on the print medium for each print line based on image data.

The motor driving unit 66 is connected to the conveyance motor 67. The motor driving unit 66 drives the conveyance motor 67 in accordance with an instruction from the processor 51. The conveyance motor 67 rotate a conveyance roller, thereby conveying, along a predetermined conveyance path, the medium to print an image. In this embodiment, the thermal printer 1 prints an image on a label material that is a print medium to print an image. For example, the conveyance motor 67 conveys label paper formed by arranging a plurality of label materials on a long band-shaped mount. In the label paper, a plurality of rectangular label materials are adhered to one surface of a long band-shaped mount at equal intervals while providing at a predetermined gap (for example, about 1 to 3 mm). The label paper is formed into a roll and, in this state, set at a predetermined position.

The ribbon driving unit 68 is connected to the ribbon motor 69. The ribbon driving unit 68 drives the ribbon motor 69 in accordance with an instruction from the processor 51. The ribbon motor 69 conveys the ink ribbon such that it is overlaid on the label paper at the print position. The ribbon motor 69 is a motor that rotates a winding roller. Also, the ribbon motor 69 may include a motor that rotates a delivery roller, and a motor that rotates a winding roller. The ribbon motor 69 rotates the winding roller or both the delivery roller and the winding roller, thereby conveying the ink ribbon.

Thinning processing for print image data by the thermal printer 1 including the image processing apparatus according to the embodiment will be described next.

The control unit 50 of the thermal printer 1 has a function of performing thinning processing for print image data upon receiving a print command. The control unit 50 stores, in the data memory 54, thinning setting information that designates print dots to be thinned from the print image data as thinning processing. The processor 51 of the control unit 50 executes thinning processing for the print image data based on the thinning setting information. The processor 51 of the control unit 50 executes print processing by the print unit 23 using the print image data that has undergone the thinning processing.

Note that the thinning processing may be executed by an information processing apparatus (image processing apparatus) communicably connected to the thermal printer 1. In this case, the information processing apparatus as the image processing apparatus need only include the same component as the control unit 50 of the thermal printer 1. Also, the information processing apparatus (image processing apparatus) need only have a function of acquiring print image data (first image data), executing thinning processing for the print image data, and supplying the image data (the print image data after the thinning processing (second image data)) that has undergone the thinning processing to the thermal printer 1.

Thinning setting information used for thinning processing by the thermal printer 1 including the image processing apparatus according to the embodiment will be described next.

The thinning setting information is information including setting information (thinning pattern) that is formed by a thinning condition and the number of dots to thin and used for thinning processing. The thinning pattern is information that associates the thinning condition and the number of dots to thin. The thinning setting information is stored in a memory such as the data memory 54.

Also, the thinning setting information may include a plurality of types of thinning patterns (setting information used for thinning processing). The thinning condition of each thinning pattern included in the thinning setting information is designated by the combination of the number of print dots continuing in the main scanning direction and the number of print dots continuing in the sub-scanning direction. The number of dots to thin of each thinning pattern is information that designates print dots to be thinned from a region (print dot group) matching the thinning condition in print image data.

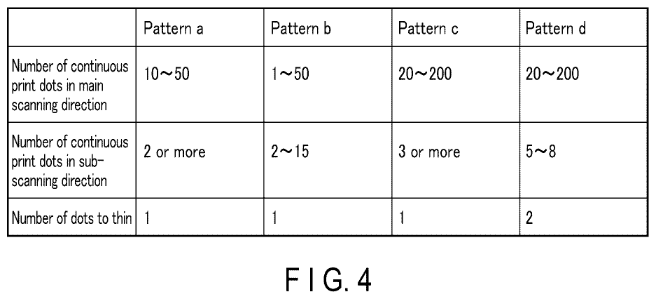

FIG. 4 is a view showing an example of setting information (thinning patterns) used for thinning processing by the thermal printer 1 including the image processing apparatus according to the embodiment.

In the example shown in FIG. 4, the thinning setting information includes four types of thinning patterns (setting information) including a pattern a, a pattern b, a pattern c, and a pattern d. Each thinning pattern is formed by a thinning condition and the number of dots to thin. The thinning condition is formed by the combination of the number of print dots continuing in the main scanning direction and the number of print dots continuing in the sub-scanning direction. The number of dots to thin indicates the number of dots to be thinned in a case of matching of the thinning condition.

In the pattern a, the thinning condition indicates that the number of print dots continuing in the main scanning direction is “10 to 50” and the number of print dots continuing in the sub-scanning direction is “2 or more”. Also, in the pattern a, the number of dots to thin is “1”. Hence, the pattern a that is one piece of setting information in the thinning setting information indicates a setting that in a print dot group (a region where print dots continue) in which the number of continuous print dots in the main scanning direction is “10 to 50” and the number of continuous print dots in the sub-scanning direction is “2 or more” in print image data, one print dot is thinned from the print dots continuing in the sub-scanning direction.

In the pattern b, the thinning condition indicates that the number of print dots continuing in the main scanning direction is “1 to 50” and the number of print dots continuing in the sub-scanning direction is “2 to 15”. Also, in the pattern b, the number of dots to thin is “1”. Hence, the pattern b indicates a setting that in a print dot group in which the number of continuous print dots in the main scanning direction is “1 to 50” and the number of continuous print dots in the sub-scanning direction is “2 to 15” in print image data, one print dot is thinned from the print dots continuing in the sub-scanning direction.

In the pattern c, the thinning condition indicates that the number of print dots continuing in the main scanning direction is “20 to 200” and the number of print dots continuing in the sub-scanning direction is “3 or more”. Also, in the pattern c, the number of dots to thin is “1”. Hence, the pattern c indicates a setting that in a print dot group in which the number of continuous print dots in the main scanning direction is “20 to 200” and the number of continuous print dots in the sub-scanning direction is “3 or more” in print image data, one print dot is thinned from the print dots continuing in the sub-scanning direction. Note that the pattern c is an example of setting information (first setting information) including a first thinning condition and a first number of dots to thin.

In the pattern d, the thinning condition indicates that the number of print dots continuing in the main scanning direction is “20 to 200” and the number of print dots continuing in the sub-scanning direction is “5 to 8”. Also, in the pattern d, the number of dots to thin is “2”. Hence, the pattern d indicates a setting that in a print dot group in which the number of continuous print dots in the main scanning direction is “20 to 200” and the number of continuous print dots in the sub-scanning direction is “5 to 8” in print image data, two print dots are thinned from the print dots continuing in the sub-scanning direction. Note that the pattern d is an example of setting information (second setting information) including a second thinning condition and a second number of dots to thin.

The control unit 50 stores the thinning setting information in, for example, the data memory 54. If a plurality of thinning patterns are stored as the thinning setting information, the processor 51 of the control unit 50 performs setting of thinning processing by one pattern or the combination of a plurality of pattens. The thinning pattern to be used for thinning processing may be instructed by the operator via the operation unit 17 or may be instructed from the host computer 2. Also, the thinning pattern may be specified by information included in a print command or may be decided in accordance with the operation mode under execution.

An example of image data generated by thinning processing by the thermal printer 1 including the image processing apparatus according to the embodiment will be described next.

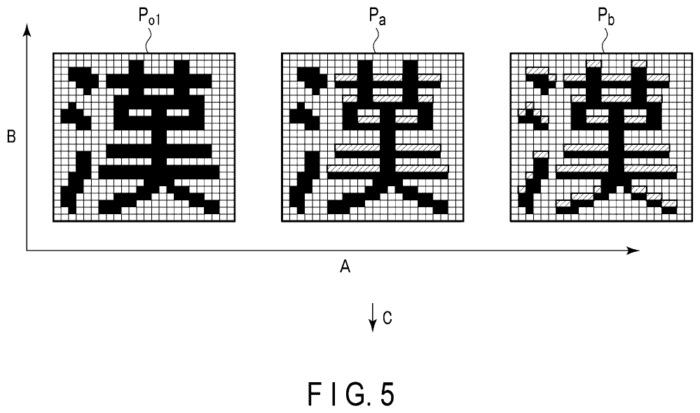

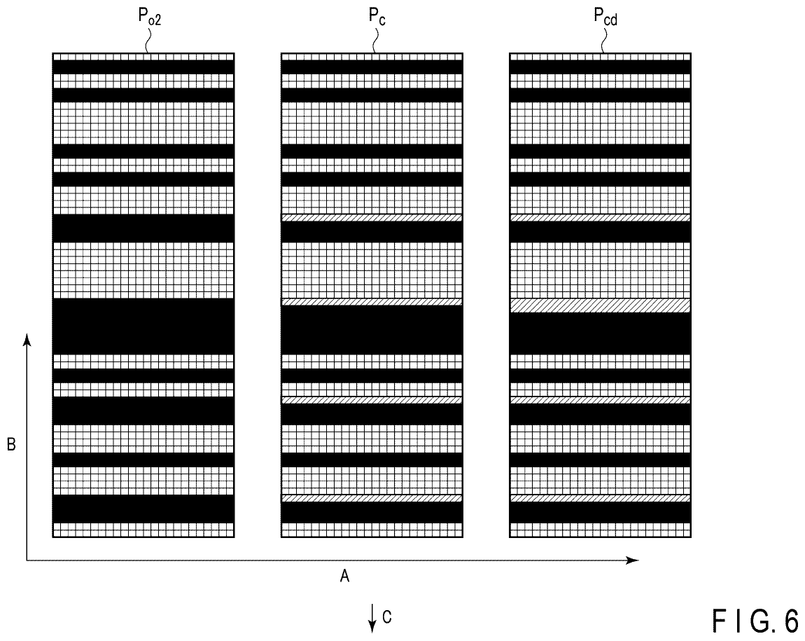

FIGS. 5 and 6 are views showing an example of image data generated by thinning processing by the thermal printer 1 including the image processing apparatus according to the embodiment.

In FIGS. 5 and 6, image data Pₒ₁ and Pₒ₂ are examples of original print image data (first image data). Also, in FIG. 5, image data Pₐ and P_{b} are examples of image data (second image data) generated by thinning processing for the image data Pₒ₁. In FIG. 6, image data P_{c} and P_{cd} are examples of image data (second image data) generated by thinning processing for the image data Pₒ₂.

Note that in FIGS. 5 and 6, a direction A indicates the main scanning direction, and a direction B indicates the sub-scanning direction. Also, in FIGS. 5 and 6, a direction C indicates the conveyance direction (print direction) of the medium to print an image. In FIGS. 5 and 6, a grid schematically indicates a pixel in the print region, a black portion indicates an actually printed pixel (a print dot or a black pixel), and a hatching portion indicates a print dot thinned by thinning processing.

The image data Pₒ₁ shown in FIG. 5 is original print image data supplied to the thermal printer 1, and is an example indicating image data used to print a character (Chinese character). In the image data Pₒ₁, a print dot group continuing in the main scanning direction (direction A) and a print dot group continuing in the sub-scanning direction (direction B) exist.

The image data Pₐ shown in FIG. 5 is image data (second image data) generated by performing thinning processing using the setting information of the pattern a shown in FIG. 4 for the image data (first image data) Pₒ₁ in FIG. 5. In the image data Pₐ, print dots of hatching portions are thinned from the print dot group in the image data Pₒ₁ shown in FIG. 5 in which the number of continuous print dots in the main scanning direction is “10 to 50” and the number of continuous print dots in the sub-scanning direction is “2 or more”.

In the thinning condition of the pattern a, the number of continuous print dots in the main scanning direction is set to “10 to 50”, and the number of continuous print dots in the sub-scanning direction is set to “2 or more”. Hence, by the thinning processing of the pattern a, in the print dot group matching the thinning condition of the pattern a, the width of the image in the sub-scanning direction is decreased by 1 dot. As a result, in the image of the print dot group matching the thinning condition of the pattern a, even if trailing occurs, the print result can be prevented from becoming large in the sub-scanning direction. Also, in the image data Pₐ, thinning is not performed even if the number of continuous print dots in the sub-scanning direction is 2 or more in the print dot group in which the number of continuous print dots in the main scanning direction is 9 or less or 51 or more.

The image data P_{b} shown in FIG. 5 is image data (second image data) generated by performing thinning processing using the setting information of the pattern b shown in FIG. 4 for the image data (first image data) Pₒ₁ in FIG. 5. As shown in FIG. 5, in the image data P_{b}, print dots of hatching portions are thinned from the print dot group in the image data Pₒ₁ in which the number of continuous print dots in the main scanning direction is “1 to 50” and the number of continuous print dots in the sub-scanning direction is “2 to 15”.

In the thinning condition of the pattern b, the number of continuous print dots in the main scanning direction is set to “1 to 50”, and the number of continuous print dots in the sub-scanning direction is set to “2 to 15”. Hence, by the thinning processing of the pattern b, in the print dot group matching the thinning condition of the pattern b, the width of the image in the sub-scanning direction is decreased by 1 dot. As a result, in the image of the print dot group matching the thinning condition of the pattern b, even if trailing occurs, the print result can be prevented from becoming large in the sub-scanning direction. Also, the image data P_{b} means that a print dot group in which the number of continuous print dots in the main scanning direction is 51 or more or the number of continuous print dots in the sub-scanning direction is 16 or more is not thinned. For this reason, in the image data P_{b}, for example, a print dot group like a rule line in the sub-scanning direction, in which the number of continuous print dots in the sub-scanning direction is 16 or more, is not thinned.

The image data Pₒ₂ shown in FIG. 6 is original print image data supplied to the thermal printer 1, and is an example indicating image data used to print a barcode. The image data Pₒ₂ shown in FIG. 6 is configured such that bars forming the barcode are arranged in the main scanning direction (direction A). In the image data Pₒ₂, the number of print dots continuing in the main scanning direction (direction A) corresponds to the length of each bar forming the barcode. Also, in the image data Pₒ₂, the number of print dots continuing in the sub-scanning direction (direction B) corresponds to the width of each bar forming the barcode.

The image data P_{c} shown in FIG. 6 is image data (second image data) generated by performing thinning processing using the setting information of the pattern c shown in FIG. 4 for the image data (first image data) Pₒ₂ in FIG. 6. In the image data P_{c}, print dots of hatching portions are thinned from the print dot group in the image data Pₒ₂ in which the number of continuous print dots in the main scanning direction is “20 to 200” and the number of continuous print dots in the sub-scanning direction is “3 or more”.

In the thinning condition of the pattern c, the number of continuous print dots in the main scanning direction is set to “20 to 200”, the number of continuous print dots in the sub-scanning direction is set to “3 or more”, and the number of dots to thin is set to “1”. Hence, by the thinning processing of the pattern c, in the print dot group matching the thinning condition of the pattern c, the width of the image in the sub-scanning direction (the image of the continuously printed portion) is decreased by 1 dot. As a result, in the image of the print dot group matching the thinning condition of the pattern c, even if trailing occurs, the print result can be prevented from becoming large in the sub-scanning direction.

Also, in the image data P_{c}, thinning is not performed even if the number of continuous print dots in the sub-scanning direction is 3 or more in the print dot group in which the number of continuous print dots in the main scanning direction is 19 or less or 201 or more. If the original print image data Pₒ₂ is an image including a barcode, as shown in FIG. 6, setting can be done such that the image portion of the barcode is set to the target of thinning processing.

For example, the number of continuous print dots in the main scanning direction can be set assuming each bar of the barcode. In this case, even if the print image data includes an image other than the barcode, the thinning condition can be set to apply thinning processing to each bar of the barcode. More specifically, the pattern c can be set not to apply thinning processing to an image portion shorter than the bar of the assumed barcode, in which the number of continuous print dots is 19 or less. Also, the pattern c can be set not to apply thinning processing to an image portion longer than the bar of the assumed barcode, in which the number of continuous print dots is 201 or more.

Furthermore, the number of continuous print dots in the sub-scanning direction can be set assuming the width of each bar of the barcode. That is, the number of continuous print dots in the sub-scanning direction can be set not to apply thinning processing to each bar having a width less than the set width and to apply thinning processing to each bar having a width equal to or more than the set width.

The image data P_{cd} shown in FIG. 6 is image data (second image data) generated by performing thinning processing using the setting information of the pattern c (first thinning setting) and the pattern d (second thinning setting) shown in FIG. 4 for the image data (first image data) Pₒ₂. That is, the image data P_{cd} is an example of second image data generated by executing thinning processing by combining thinning setting (setting information) of a plurality of different thinning conditions.

Different thinning conditions are set for the pattern c and the pattern d, and the thinning condition of the pattern c is set such that it includes the thinning condition of the pattern d. Furthermore, the number of dots to thin of the pattern d is set such that it is larger than the number of dots to thin of the pattern c. When performing thinning processing by combining the pattern c and the pattern d, thinning processing is executed based on the number of dots to thin of the pattern d for a print dot group matching the pattern d, and thinning processing is executed based on the number of dots to thin of the pattern c for a print dot group matching not the pattern d but the pattern c.

More specifically, in the image data Pₒ₂, in a print dot group in which the number of continuous print dots in the main scanning direction is “20 to 200”, the number of dots to thin is set to “2” for a print dot group in which the number of continuous print dots in the sub-scanning direction is “5 to 8”, and the number of dots to thin is set to “1” for a print dot group in which the number of continuous print dots in the sub-scanning direction is “3 to 4” or “9 or more”. However, when combining the pattern c and the pattern d, setting may be done not to apply thinning processing to a print dot group in which the number of continuous print dots in the sub-scanning direction is 9 or more.

That is, by the thinning processing combining the pattern c and the pattern d, in the print dot group matching the thinning condition of the pattern d, the width of the image in the sub-scanning direction (the image of the continuously printed portion) is decreased by 2 dots. Furthermore, by the thinning processing combining the pattern c and the pattern d, in the print dot group matching only the thinning condition of the pattern c, the width of the image in the sub-scanning direction is decreased by 1 dot. As a result, in the image portion matching the pattern d, even if trailing corresponding to 2 dots occurs, a proper print result can be obtained. In the image portion matching only the pattern c, even if trailing corresponding to 1 dot occurs, a proper print result can be obtained.

Additionally, in the pattern c and the pattern d, the number of continuous print dots in the main scanning direction is set assuming the length of each bar of the barcode. In this case, in the image data P_{cd}, a print dot group out of the assumed length of the bar of the barcode (a print dot group in which the number of continuous print dots in the main scanning direction is 19 or less or 201 or more) is not thinned. That is, if the original print image data Pₒ₂ is an image including a barcode, as shown in FIG. 6, setting can be done such that the image portion of the barcode is set to the target of thinning processing. In addition, by combining the pattern c and the pattern d, the number of dots to thin can be set in accordance with the number of continuous print dots in the sub-scanning direction (set assuming the width of each bar of the barcode).

The procedure of print processing including thinning processing in the thermal printer 1 including the image processing apparatus according to the embodiment will be described next.

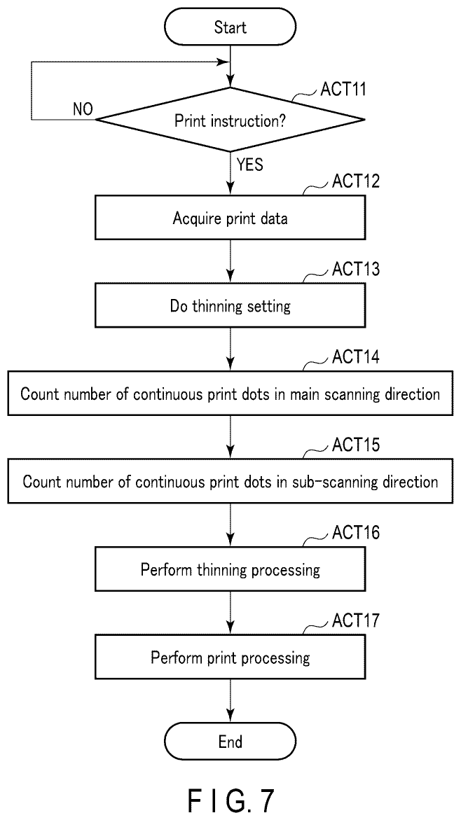

FIG. 7 is a flowchart for explaining the procedure of print processing including thinning processing in the thermal printer 1 including the image processing apparatus according to the embodiment.

The processor 51 of the thermal printer 1 accepts a print instruction for instructing execution of print in the standby state (ACT11). For example, the processor 51 accepts a print command as a print instruction by instruction input to the operation unit 17 or a print instruction from the host computer 2 connected via the communication unit 55.

Upon accepting the print instruction (print command), the processor 51 acquires print image data that is the target of print processing (ACT12). Upon acquiring the print image data, the processor 51 performs setting of thinning processing for the print image data (ACT13). AS the setting of thinning processing (thinning setting), the processor 51 sets setting information (thinning pattern) used for thinning processing based on thinning setting information stored in a memory such as the data memory 54.

If the thinning setting information includes a plurality of pieces of setting information (thinning patterns), the processor 51 specifies a thinning pattern to be applied to the print image data from the thinning patterns included in the thinning setting information. For example, the processor 51 may set a thinning pattern designated in advance or may cause the operator to select a thinning pattern before print. Alternatively, the processor 51 may decide the thinning pattern to be used for thinning processing from information included in the print command. Furthermore, the processor 51 may decide the thinning pattern in accordance with a designated operation mode.

Also, the processor 51 may set one thinning pattern or a combination of a plurality of thinning patterns as the thinning setting. For example, to obtain the image data Pₐ and P_{b} shown in FIG. 5 or the image data P_{c} shown in FIG. 6, one of the patterns a, b, and c is set as the thinning setting. Also, to obtain the image data P_{cd} shown in FIG. 6, the combination of the pattern c and the pattern d may be set as the thinning setting.

To execute thinning processing according to the thinning setting, the processor 51 counts the number of continuous print dots in the main scanning direction in the print image data (ACT14). The processor 51 also counts the number of continuous print dots in the sub-scanning direction in the print image data (ACT15).

After the numbers of continuous print dots in the main scanning direction and the sub-scanning direction are counted, the processor 51 executes thinning processing by applying the thinning pattern set in the thinning setting (ACT16). The processor 51 thins print dots designated by the thinning pattern from a print dot group matching the thinning condition of the thinning pattern in the print image data. If a combination of a plurality of thinning patterns is set, the processor 51 executes thinning processing by combining the thinning patterns. For example, when combining two different patterns, the processor 51 performs thinning processing using the larger number of dots to thin for a print dot group matching the thinning conditions of both patterns. In addition, for a print dot group matching not one pattern but the other pattern, the processor 51 performs thinning processing using the number of dots to thin of the other pattern.

If the thinning processing for the entire print image data is completed, the processor 51 executes print processing by the thermal head 33 using the image data (second image data) that has undergone the thinning processing (ACT17). The processor 51 executes print processing by print control including heat history control by the print unit 23 using the image data after the thinning processing. The processor 51 may sequentially execute thinning processing for each line of the print image data and execute print processing by outputting the line that has undergone the thinning processing to the print unit 23 at any time.

As described above, the thermal printer according to the embodiment executes thinning processing for print image data before execution of heat history control for the thermal head. Thus, the thermal printer according to the embodiment can suppress trailing and blur, which cannot be eliminated only by heat history control.

It is also possible to perform thinning processing according to a thinning condition for print image data that is acquired together with a print command and set the number of continuous print dots in the main scanning direction by the thinning condition. Hence, the printer according to the embodiment can perform not only correction for each line in the main scanning direction but also thinning processing for some continuous print dot groups in the main scanning direction. As a result, some specific images in print image data, like a bar of a barcode, can be set to the target of thinning processing.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image processing apparatus used in a thermal printer and configured to process image data, comprising:
a memory configured to store setting information in which the number of continuous print dots in a main scanning direction and the number of continuous print dots in a sub-scanning direction as a thinning condition to execute thinning of a print dot are set; and
a processor configured to generate second image data by thinning a print dot in accordance with the setting information from a print dot group in which the number of continuous print dots in the main scanning direction and the number of continuous print dots in the sub-scanning direction in first image data match the thinning condition.

2. The apparatus according to claim 1, wherein
in the setting information, the number of dots to thin is set in correspondence with the thinning condition, and
the processor thins print dots as many as the number of dots to thin from print dots continuing in the sub-scanning direction in the print dot group matching the thinning condition.

3. The apparatus according to claim 1, wherein
in the setting information, the number of continuous print dots in the main scanning direction is not more than a predetermined number.

4. The apparatus according to claim 3, wherein
in the setting information, the number of continuous print dots in the main scanning direction is set to not more than the number of print dots corresponding to a length of a bar forming a barcode.

5. The apparatus according to claim 2, wherein
in the setting information, a first number of dots to thin is set in correspondence with a first thinning condition, and a second number of dots to thin larger than the first number of dots to thin is set in correspondence with a second thinning condition included in the first thinning condition, and
the processor thins print dots as many as the second number of dots to thin in a print dot group matching the second thinning condition, and thins print dots as many as the first number of dots to thin in a print dot group matching not the second thinning condition but the first thinning condition.

6. The apparatus according to claim 5, wherein
in the second thinning condition, the number of continuous print dots in the sub-scanning direction is larger than in the first thinning condition.

7. The apparatus according to claim 4, wherein
in the setting information, a first number of dots to thin is set in correspondence with a first thinning condition, and a second number of dots to thin larger than the first number of dots to thin is set in correspondence with a second thinning condition included in the first thinning condition, and
the processor thins print dots as many as the second number of dots to thin in a print dot group matching the second thinning condition, and thins print dots as many as the first number of dots to thin in a print dot group matching not the second thinning condition but the first thinning condition.

8. The apparatus according to claim 7, wherein
in the second thinning condition, the number of continuous print dots in the sub-scanning direction is larger than in the first thinning condition.

9. A printer comprising:
a thermal head including a plurality of heating elements arranged in a main scanning direction;
a memory configured to store setting information in which the number of continuous print dots in the main scanning direction and the number of continuous print dots in a sub-scanning direction as a thinning condition to execute thinning of a print dot are set;
a processor configured to generate second image data by thinning a print dot in accordance with the setting information from a print dot group in which the number of continuous print dots in the main scanning direction and the number of continuous print dots in the sub-scanning direction in first image data match the thinning condition; and
a driving unit configured to drive the thermal head in accordance with the second image data.

10. The printer according to claim 9, wherein
in the setting information, the number of dots to thin is set in correspondence with the thinning condition, and
the processor thins print dots as many as the number of dots to thin from print dots continuing in the sub-scanning direction in the print dot group matching the thinning condition.

11. The printer according to claim 10, wherein
in the setting information, the number of continuous print dots in the main scanning direction is not more than a predetermined number.

12. The printer according to claim 11, wherein
in the setting information, the number of continuous print dots in the main scanning direction is set to not more than the number of print dots corresponding to a length of a bar forming a barcode.

13. The printer according to claim 10, wherein
in the setting information, a first number of dots to thin is set in correspondence with a first thinning condition, and a second number of dots to thin larger than the first number of dots to thin is set in correspondence with a second thinning condition included in the first thinning condition, and
the processor thins print dots as many as the second number of dots to thin in a print dot group matching the second thinning condition, and thins print dots as many as the first number of dots to thin in a print dot group matching not the second thinning condition but the first thinning condition.

14. The printer according to claim 13, wherein
in the second thinning condition, the number of continuous print dots in the sub-scanning direction is larger than in the first thinning condition.

15. The printer according to claim 12, wherein
in the setting information, a first number of dots to thin is set in correspondence with a first thinning condition, and a second number of dots to thin larger than the first number of dots to thin is set in correspondence with a second thinning condition included in the first thinning condition, and
the processor thins print dots as many as the second number of dots to thin in a print dot group matching the second thinning condition, and thins print dots as many as the first number of dots to thin in a print dot group matching not the second thinning condition but the first thinning condition.

16. The printer according to claim 15, wherein
in the second thinning condition, the number of continuous print dots in the sub-scanning direction is larger than in the first thinning condition.

17. A non-transitory storage medium storing a program configured to cause a processor that is used in a thermal printer and configured to process image data to execute:
setting the number of continuous print dots in a main scanning direction and the number of continuous print dots in a sub-scanning direction as a thinning condition to execute thinning of a print dot;
counting the number of continuous print dots in the main scanning direction and the number of continuous print dots in the sub-scanning direction in first image data; and
generating second image data by thinning a print dot from a print dot group matching the thinning condition in the first image data.

18. The medium according to claim 17, wherein
the program causes the processor to execute:
setting the number of dots to thin corresponding to the thinning condition; and
generating the second image data by thinning print dots as many as the number of dots to thin from print dots continuing in the sub-scanning direction in the print dot group matching the thinning condition.

19. The medium according to claim 18, wherein
the program causes the processor to execute:
setting the number of continuous print dots in the main scanning direction to not more than the number of print dots corresponding to a length of a bar forming a barcode.

20. The medium according to claim 17, wherein
the program causes the processor to execute:
setting a first number of dots to thin in correspondence with a first thinning condition;
setting a second number of dots to thin larger than the first number of dots to thin in correspondence with a second thinning condition included in the first thinning condition; and
generating the second image data by thinning print dots as many as the second number of dots to thin in a print dot group matching the second thinning condition and thinning print dots as many as the first number of dots to thin in a print dot group matching not the second thinning condition but the first thinning condition.
